(19) United States
(12) Patent Application Publication
(10) Pub. No.: US 2005/0184033 A1
(43) Pub. Date: Aug. 25, 2005

(54) Utilization of a process gas mixture and method for laser beam welding

(76) Inventor: Johann Herrmann, Unterschleissheim (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/472,251

(22) PCT Filed: Mar. 21, 2001
(86) PCT No.: PCT/EP01/03241

(51) Int. Cl. B23K 9/00

(52) U.S. Cl. 219/121.36

(57) ABSTRACT

The invention describes process gas mixtures for laser beam welding that contain at least one noble gas component. Pursuant to the invention the process gas mixture contains between 50 vpm and 15.0% by volume hydrogen. The process gas can preferably contain one or more of the noble gas components helium, argon and neon. Moreover, the process gas can contain nitrogen. The process gas mixtures can be used in a method for laser beam welding, especially for welding high-grade steels, wherein a focused laser beam is directed at the workpiece surface that is to be machined. Special benefits are associated with ternary or quaternary process gas mixtures with helium and/or neon, hydrogen and nitrogen (for austenitic steels) and helium and/or neon, hydrogen and argon (for titanium or titanium-stabilized steels).

This application claims the priority of PCT/EP00/03241, filed Mar. 21, 2001, the disclosure of which is expressly incorporated by reference herein.

### BACKGROUND AND SUMMARY OF THE INVENTION

The invention relates to the use of a process gas mixture for laser beam welding, wherein the process gas mixture contains at least one noble gas. The invention furthermore relates to a method for laser beam welding, wherein a focused laser beam is directed at the workpiece surface that is to be machined and a process gas flow is conducted against the workpiece surface via at least one nozzle that is arranged coaxially and/or at an angle in relation to the laser beam axis.

The characteristics of laser radiation, especially its intensity and good focusability, have led to the fact that today use of lasers in many material machining areas. Known laser machining equipment unless a laser machining head, possibly with a nozzle that is arranged coaxially to the laser beam. Laser machining equipment is frequently used in connection with CNC controls.

Process gases are employed with different objectives, in particular also as protective gases, in various machining methods, including in laser beam welding processes. It is intended to optimize gas mixtures with respect to these objectives. Process gases are generally required on or at least in the surroundings of the machined area especially when functioning as protective gases in a pure state, i.e. without interfering components of the ambient atmosphere.

German Reference DE 196 16 844 A1 discloses a method for laser welding metallic workpieces while employing a process gas that flushes the weld area and consists of a mixture of at least one inert gas and hydrogen. The process gas then contains at least one noble gas and/or nitrogen as the inert gas. The process gas contains hydrogen at a percentage from 1 to 30% by volume. The metallic workpieces mentioned are workpieces made of austenitic steel, austenitic-ferritic steel or of a nickel base alloy. The effect of adding hydrogen pursuant to DE 196 16 844 A1 is that the formation of plasma flares, i.e. a plasma formation in the process gas already before the laser beam hits the metal surface, is prevented or reduced.

German Reference DE 43 15 849 C1 provides a method for the CO₂ laser beam welding of aluminum alloys while employing a shielding gas or gas mixture, which is directed at the welding point on the workpiece surface through shielding and working nozzles for plasma control. The welding shielding gas consists of either pure neon or a gas mixture comprising argon, helium, nitrogen, carbon dioxide, hydrogen and oxygen with pure neon, wherein the volume portion of pure neon in the respective mixture is more than 25%.

Laser beam welding with the aid of process gases accomplishes above all one objective. At high laser output levels the plasma formation (as a function of laser output, laser type, energy density, evaporated material volume, welding speed and also of the protective gas type) must be presented from becoming too great. Otherwise the laser radiation is absorbed, deflected and/or disturbed by the generated plasma, causing the welding process to become unstable or even to collapse. The basic tasks of the process gas are the control and, especially with high laser output levels, the reduction of plasma. Beneficial for the solution of this problem are gases such as helium with high thermal conductivity and a high ionization temperature.

However, there are other possibilities for influencing the welding process through the selection of the process gas. By means of a gas, the weld seam can be covered and thus protected from damaging effects by the ambient atmosphere (protective gas). Favorable factors here are low flow speeds and heavy gases, which can be supplied coaxially and/or at an angle (e.g. about 30°) to the laser beam axis.

Other possible objectives such as metallurgical optimization and/or a maximization of the speed and/or quality (spatters, drilling, seam geometry) are today still largely neglected. Moreover the price of the process gas that is employed plays quite a considerable role in its selection.

When welding high-grade steels, the most important tasks that have to be fulfilled in the optimization of the welding process through the selection of the process gas include the freedom from oxide, as well as plasma control, weld speed and weld depth. The gases that can be employed as a rule and hereby offer conditions with different benefit levels in every respect.

Particularly with the laser beam welding of high-grade steels—especially when laser beam welding austenitic steels—but also with the laser beam welding of titanium or of titanium-stabilized steels it is problematic to find suitable compositions for the process gas mixtures that lead to an optimization of the welding process.

It is, therefore, the object of the present invention to present a process gas mixture for use in laser beam welding and a method for laser beam welding of the above-described kind, which improves and optimizes the laser machining process through a suitable gas composition. Hereby economical aspects shall be considered as much as possible as well.

This object is achieved pursuant to the invention in that the process gas mixture on one hand comprises between 50 vpm (0.005% by volume) and 15.0% by volume hydrogen and on the other hand 5 to 75% by volume helium or 10 to 80% by volume neon or an overall portion of helium and neon of 5 to 80% by volume.

Hydrogen can easily take energy away from the plasma because it has a high thermal capacity and thermal conductivity. However, it forms plasma already at low temperatures (e.g. at 4,000° C.).

The process gas mixture pursuant to the invention contains between 50 vpm (0.005% by volume) and 15.0% by volume, preferably between 0.01 and 5.0% by volume, particularly between 0.5 and 4.5% by volume hydrogen. It has been shown that process gas mixture with a hydrogen portion as that pursuant to the invention lead to good welding results. Hydrogen can aid in binding oxygen and thus minimizing oxidation. Moreover, an increased speed in the laser beam welding process can be achieved through the addition of hydrogen in the process gas. A limitation of the hydrogen portion in the process gas mixture is furthermore also recommended for safety reasons because higher hydrogen percentages can facilitate ignition.

Preferably a binary mixture of helium or neon and hydrogen or particularly preferred a ternary, quaternary or higher gas mixture comprising preferably hydrogen and helium and/or neon is used.

Pursuant to the invention, the process gas contains one or more of the noble gas components helium, argon and neon.

Helium dilutes and thus controls the plasma the best because with helium the plasma formation occurs not until temperatures between 15,000° C. and 20,000° C. are reached. The less expensive argon has a lesser effect than helium with respect of the plasma. Argon can be employed especially for highly reactive metals such as titanium or titanium-stabilized steels. Neon is between helium and argon in its physical and chemical properties.

The process gas can contain especially 5 to 75% by volume, preferably 15 to 50% by volume, particularly preferred 20 to 35% by volume helium.

Benefits during laser beam welding however can also be achieved when the process gas contains especially 10 to 80% by volume, preferably 20 to 60% by volume, particularly preferred 25 to 45% by volume neon.

Process gas mixtures containing helium and neon are also suitable. The process gas can here have an overall portion of helium and neon of 5 to 80% by volume, preferably 15 to 60% by volume, particularly preferred 20 to 45% by volume.

Beneficially the process gas can contain nitrogen.

The likewise inexpensive nitrogen has an effect comparable to argon regarding plasma control. However the use of nitrogen-containing process gas mixtures should be avoided when welding highly reactive metals such as titanium or titanium-stabilized steels because it can lead to nitrite formation.

It has been found that an optimization with respect to the various objectives of the process gas can be achieved excellently through the composition of the process gas mixtures.

In the designs of the invention ternary or quaternary process gas mixtures are recommended due to their excellent suitability for laser beam welding.

The ternary process gas mixture can here be composed of
Helium, hydrogen and nitrogen,
Helium, hydrogen and argon,
Neon, hydrogen and nitrogen or
Neon, hydrogen and argon.

The quaternary process gas mixture can here be composed in particular of
Helium, neon, hydrogen and nitrogen, or
Helium, neon, hydrogen and argon.

Pursuant to the invention beneficially ternary or quaternary process gas mixtures with
20 to 50% by volume helium and/or neon, 50 vpm (0.005% by volume) to 15.0% by volume hydrogen and the remainder being argon or
20 to 50% by volume helium and/or neon, 50 vpm (0.005% by volume) to 15.0% by volume hydrogen and the remainder being nitrogen
   can be used.

In the above-listed ternary and quaternary mixtures, the hydrogen portion can also be between 0.01 and 5.0% by volume or even between 0.5 and 4.5% by volume.

For laser beam welding austenitic steels, pursuant to the invention the use of a process gas mixture is recommended that consists of helium and/or neon and additionally nitrogen. For laser beam welding titanium or titanium-stabilized steels, pursuant to the invention the use of a process gas mixture is recommended that contains helium and/or neon and additionally hydrogen and argon.

When laser beam welding austenitic steels, titanium or titanium-stabilized steels the helium portion in ternary mixtures is preferably around 25% by volume. With a partial or complete substitution of helium with neon, the percentage used should be accordingly higher than the helium portion.

The process gas mixtures described above can be used beneficially in a method for laser beam welding, especially for welding high-grade steels or titanium or titanium-stabilized steels. A focused laser beam is directed at the workpiece surface that is to be machined and at least one process gas flow is directed against the workpiece surface via at least one nozzle that is arranged coaxially or at an angle to the laser beam axis.

A focused laser beam within the framework of the invention should be interpreted as a laser beam that is substantially focused on the workpiece surface. Apart from the primarily employed method with laser radiation that is focused on the workpiece surface, the invention can also be applied to the rarely used variation with radiation that is not exactly focused on the workpiece surface.

The invention is in principle not limited to the use of special types of lasers. For the laser beam welding process above all CO₂ lasers or Nd:YAG lasers are suitable.

1-11. (canceled)

12. A welding gas mixture for a laser beam welding process, comprising hydrogen in an amount between 0.005% and 1.50% by volume; and
one of helium between 5% and 75% and neon between 10% and 80% and a combination of helium and neon between 5 and 80% by volume.

13. The welding gas mixture pursuant to claim 12, wherein the gas mixture contains hydrogen between 0.01 and 5.0% by volume.

14. The welding gas mixture pursuant to claim 12, wherein the gas mixture contains argon.

15. The welding gas mixture pursuant to claim 12, wherein the gas mixture contains helium between 15 to 50% by volume.

16. The welding gas mixture pursuant to claim 12, wherein the gas mixture contains neon between 20 to 60% by volume.

17. The welding gas mixture pursuant to claim 12, wherein the gas mixture contains an overall portion of helium and neon of 15 to 60% by volume.

18. The welding gas mixture pursuant to claim 12, wherein the gas mixture contains nitrogen.

19. The welding gas mixture pursuant to claim 12, wherein the gas mixture is a ternary mixture of one of:
Helium, hydrogen and nitrogen;
Helium, hydrogen and argon;
Neon, hydrogen and nitrogen; and
Neon, hydrogen and argon.

20. The welding gas mixture pursuant to claim 12, wherein the gas mixture is a quaternary mixture of one of:
Helium, neon, hydrogen and nitrogen; and
Helium, neon, hydrogen and argon.

21. The welding gas mixture pursuant to claim 19, wherein the welding mixture gas contains one of:
20 to 50% by volume helium and/or neon, 50 vpm (0.005% by volume) to 15.0% by volume hydrogen and the remainder being argon; and
20 to 50% by volume helium and/or neon, 50 vpm (0.005% by volume) to 15.0% by volume hydrogen and the remainder being nitrogen.

22. A method for laser beam welding, comprising the steps of:
directing a focused laser beam at a workpiece to be machined; and
flowing a welding gas mixture having a composition according to claim 1, wherein said welding gas mixture is flowed against said workpiece surface by at least one nozzle arranged one of coaxially and at an angle to an axis of said focused laser beam.

23. The welding gas mixture pursuant to claim 15, wherein the gas mixture contains helium between 20 to 35% by volume.

24. The welding gas mixture pursuant to claim 16, wherein the gas mixture contains neon between 25 to 45% by volume.

25. The welding gas mixture pursuant claim 17, wherein the gas mixture contains an overall portion of helium and neon between 20 to 45%.
